(19) United States
(12) Patent Application Publication
(10) Pub. No.: US 2006/0185526 A1
(43) Pub. Date: Aug. 24, 2006

(54) Movable bucket and matching fixed bucket for an ice-cream machine and an ice-cream machine with said movable bucket and matching fixed bucket

(76) Inventor: Donglei Wong, Zhuhai City (CN)

Correspondence Address: CARSTENS & CAHOON, LLP, P O BOX 802334, DALLAS, TX, 75380, US

(21) Appl. No.: 11/356,394

(22) Filed: Feb. 16, 2006

(30) Foreign Application Priority Data
Feb. 19, 2005 (CN) 2005-20054964.0

(51) Int. Cl. A47J 37/10; F25D 3/08

(52) U.S. Cl. 99/425; 62/1

(57) ABSTRACT

The present invention discloses a movable bucket and a matching fixed bucket used in an ice-cream machine, and an ice-cream machine equipped with said movable bucket and matching fixed bucket, wherein the movable bucket and the matching fixed bucket are made of a heat-transferable material, the matching fixed bucket is refrigerated when the ice-cream machine works, the movable bucket accommodates materials for making ice cream and is put into the matching fixed bucket when making ice cream, and wherein the outer wall of the movable bucket and the inner wall of the matching fixed bucket have a same slope above zero, so that the outer wall of the movable bucket and the inner wall of the matching fixed bucket can be in well contact.

### CROSS-REFERENCE TO RELATED APPLICATION

This application claims priority of CN Patent Application No. 200520054964.0 filed on Feb. 19, 2005, entitled “A Movable Bucket and Matching Fixed Bucket for an ice-cream Machine and an Ice-cream Machine with said Movable Bucket and Matching Fixed Bucket”, which is incorporated herein by reference for all purposes.

### BACKGROUND OF THE INVENTION

1. Technical Field

This invention relates to a movable bucket and a matching fixed bucket in an ice-cream machine, and to an ice-cream machine equipped with said movable bucket and matching fixed bucket.

2. Description of Related Art

A top-opened domestic ice cream machine is one of modem household electric appliances, which comprises a shell, a base, a controller, a movable bucket for accommodating the materials for making ice cream, a matching fixed bucket, and a freezing cycle mounted on the base comprising a compressor, a condenser, a fan and an evaporator. Wherein said movable bucket and said matching fixed bucket are made of heat-transferable materials; and wherein said evaporator is wound on the outer surface of the fixed bucket, and said movable bucket is placed inside said matching fixed bucket when making ice cream. A cover assembly is placed on the top of the movable bucket and fixed bucket, wherein a motor is included in said cover assembly, the output shaft of the motor extends downward; and the lower end of the output shaft is connected with a stirring blender, which is located in the center of the movable bucket. As the ice-cream machine works, the refrigerating effect produced by the freezing cycle is transferred from the evaporator to the matching fixed bucket, and the temperature of the movable bucket gradually falls accordingly. At the same time, the materials in the movable bucket are blended by the stirring blender under the control of the controller, so that the ice cream is made.

After the ice cream is made, the user may open the cover, remove the stirring blender, and take out the movable bucket to enjoy the ice cream inside.

Since the refrigerating effect is obtained by heat transfer from the fixed bucket to the movable bucket, the movable bucket should be in well contact with the matching fixed bucket in order to achieve a high efficiency of refrigerating transfer.

In prior arts, both of the matching fixed bucket and the movable bucket are of cylinder shape, wherein the walls are straight and have no slope, therefore a larger force is needed to put in and pull out the movable bucket from the fixed bucket, the operation is inconvenient, the movable bucket is easily to be damaged or eroded, and has shortened lifetime. Moreover, once the shape of the buckets is changed by a little, the moveable bucket will not be able to be put into the matching fixed bucket. Therefore, the space between the existing movable bucket and the matching fixed bucket is generally large and the refrigerating transfer efficiency is affected. At present, all of the ice-cream machines in the market adopt the movable bucket and the matching fixed bucket with straight walls, thus it takes a long time to make ice cream because of the poor matching and low refrigerating transfer efficiency.

### SUMMARY OF THE INVENTION

The present invention provides a movable bucket and a matching fixed bucket and an ice-cream machine with said movable bucket and matching fixed bucket, wherein the ice-cream machine can be operated conveniently, have a high refrigerating transfer efficiency, and needs a shorter time for making ice cream.

In accordance with the invention, a movable bucket and a matching fixed bucket for use in an ice-cream machine are provided, wherein the movable bucket and the matching fixed bucket are made of a heat-transferable material, the matching fixed bucket is refrigerated when the ice-cream machine works, the movable bucket accommodates materials for making ice cream and is put into the matching fixed bucket when making ice cream, and wherein the outer wall of the movable bucket and the inner wall of the matching fixed bucket have a same slope above zero, so that the outer wall of the movable bucket and the inner wall of the matching fixed bucket are in well contact.

The wall of the movable bucket or the wall of the matching fixed bucket is of an even thickness.

The generatrix of the outer wall of the movable bucket or the generatrix of the inner wall of the matching fixed bucket is a straight line or an arc.

The slope of the outer wall of the movable bucket or the slope of the inner wall of the matching fixed bucket is within 0.5˜10 degrees.

In accordance with the invention, there is provided an ice-cream machine comprising a shell, a base, a controller, a movable bucket for accommodating the materials for making ice cream, a matching fixed bucket, and a freezing cycle mounted on the base, wherein said movable bucket and said matching fixed bucket are made of heat-transferable materials, and wherein the matching fixed bucket is refrigerated when the ice-cream machine works, the movable bucket accommodates materials for making ice cream and is put into the matching fixed bucket when making ice cream, and wherein the outer wall of the movable bucket and the inner wall of the matching fixed bucket have a same slope above zero, so that the outer wall of the movable bucket and the inner wall of the matching fixed bucket are in well contact.

On account of the above-described technical scheme, the invention has following advantages:

1. The movable bucket can be put in and pulled out from the matching fixed bucket conveniently.

2. The movable bucket can be kept from damaging so that it has a longer lifetime.

3. The contact area between the movable bucket and the matching fixed bucket is enlarged, so that the refrigerating transfer efficiency is improved by 20%-30% and the time for making ice cream is shorten.

### BRIEF DESCRIPTION OF THE DRAWINGS

FIG. 1 is a schematic view showing a movable bucket and a matching fixed bucket used in an ice-cream machine according to one embodiment of the present invention;

FIG. 2 is a schematic view showing an ice-cream machine according to one embodiment of the present invention.

### DETAILED DESCRIPTION OF THE PREFERRED EMBODIMENT

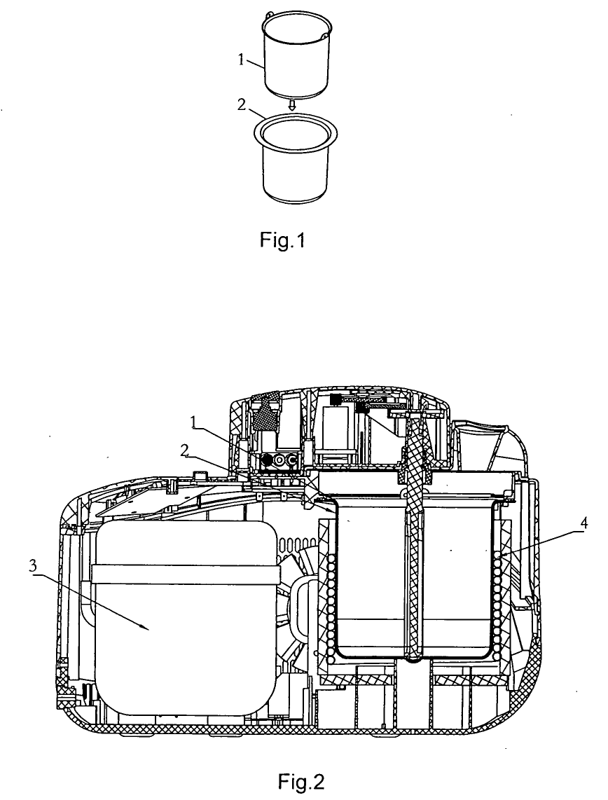

As shown in FIG. 1, in one embodiment, the movable bucket 1 and the matching fixed bucket 2 used in an ice-cream machine are both made of heat-transferable material, and the movable bucket 1 can be put in the matching fixed bucket 2 and can be pulled out conveniently. The generatrix of the outer wall of the movable bucket 1 and the generatrix of the inner wall of the matching fixed bucket 2 are straight lines. The wall of the movable bucket 1 and the wall of the matching fixed bucket 2 are of an even thickness. The slope of the walls of the movable bucket 1 and the matching fixed bucket 2 is within 0.5˜10 degrees. The movable bucket 1 and the matching fixed bucket 2 are in well contact when making ice cream.

As shown in FIG. 2, an ice-cream machine of the present invention comprises a shell, a base, a controller, a movable bucket 1, a matching fixed bucket 2, and a freezing cycle mounted on the base comprising a compressor 3, a condenser, a fan and an evaporator 4. Wherein the movable bucket 1 and the matching fixed bucket 2 are as above described with reference to FIG. 1. The evaporator 4 is wound on the outer surface of the fixed bucket 2, and the movable bucket 1 is placed inside the matching fixed bucket 2. A cover assembly is placed on the top of the movable bucket 1 and fixed bucket 2, wherein a motor is included in said cover assembly, the output shaft of the motor extends downward; and the lower end of the output shaft is connected with a stirring blender, which is located in the center of the movable bucket 1. As the ice-cream machine works, the refrigerating effect produced by the freezing cycle is transferred from the evaporator 4 to the matching fixed bucket 2, and the temperature of the movable bucket 1 gradually falls accordingly. At the same time, the materials in the movable bucket are blended by the stirring blender under the control of the controller, so that the ice cream is made.

1. A movable bucket and a matching fixed bucket used in an ice-cream machine, wherein the movable bucket and the matching fixed bucket are made of a heat- transferable material, the matching fixed bucket is refrigerated when the ice-cream machine works, the movable bucket accommodates materials for making ice cream and is put into the matching fixed bucket when making ice cream, and wherein the outer wall of the movable bucket and the inner wall of the matching fixed bucket have a same slope above zero, so that the outer wall of the movable bucket and the inner wall of the matching fixed bucket are in well contact.

2. A movable bucket and a matching fixed bucket according to claim 1, wherein the wall of the movable bucket or the wall of the matching fixed bucket is of an even thickness.

3. A movable bucket and a matching fixed bucket according to claim 1, wherein the generatrix of the outer wall of the movable bucket or the generatrix of the inner wall of the matching fixed bucket is a straight line or an arc.

4. A movable bucket and a matching fixed bucket according to claim 1, wherein the slope of the outer wall of the movable bucket or the slope of the inner wall of the matching fixed bucket is within 0.5˜10 degrees.

5. An ice-cream machine, comprising a shell, a base, a controller, a movable bucket for accommodating the materials for making ice cream, a matching fixed bucket, and a freezing cycle mounted on the base, wherein said movable bucket and said matching fixed bucket are made of heat-transferable materials, and wherein the matching fixed bucket is refrigerated when the ice-cream machine works, the movable bucket accommodates materials for making ice cream and is put into the matching fixed bucket when making ice cream, and wherein the outer wall of the movable bucket and the inner wall of the matching fixed bucket have a same slope above zero, so that the outer wall of the movable bucket and the inner wall of the matching fixed bucket are in well contact.

6. An ice-cream machine according to claim 5, wherein the wall of the movable bucket or the wall of the matching fixed bucket is of an even thickness.

7. An ice-cream machine according to claim 5, wherein the generatrix of the outer wall of the movable bucket or the generatrix of the inner wall of the matching fixed bucket is a straight line or an arc.

8. An ice-cream machine according to claim 5, wherein the slope of the outer wall of the movable bucket or the slope of the inner wall of the matching fixed bucket is within 0.5˜10 degrees.
